(19) United States
(12) Patent Application Publication
(10) Pub. No.: US 2018/0237927 A1
(43) Pub. Date: Aug. 23, 2018

(54) METHOD FOR PRODUCING THREE-DIMENSIONAL ORDERED POROUS MICROSTRUCTURES

(71) Applicant: Taiwan Advanced NanoTemplate Technology Inc., Taoyuan City (TW)

(72) Inventors: Chen-Hung LIAO, Taoyuan City (TW); Yi-Fan HSIEH, Taoyuan City (TW); Yu CHENG, Taoyuan City (TW)

(21) Appl. No.: 15/519,004

(22) PCT Filed: Nov. 11, 2016
(86) PCT No.: PCT/CN2016/105422

§ 371 Date: Apr. 13, 2017

(30) Foreign Application Priority Data
Nov. 11, 2015 (CN) 201510764258.3

(51) Int. Cl. C25D 1/00; G02B 1/00; C25D 1/08; C25D 3/12; C25D 3/48; C25D 13/04

(52) U.S. Cl. CPC C25D 1/003; G02B 1/005; C25D 13/04; C25D 3/12; C25D 3/48; C25D 1/08

(57) ABSTRACT

The invention relates to methods for producing three-dimensional ordered porous microstructures. Particularly, the invention involves facilitating the self-assembling of particles, thereby forming a three-dimensional ordered microstructure composed of a close-packing of the particles. The invention further involves forming a sacrificial layer between the three-dimensional ordered microstructure and the substrate. An inverse opal material is then filled into the interstitial voids among the particles. The particles are removed after the inverse opal material is cured, thereby producing a three-dimensional ordered porous microstructure with excellent integrity and high reproducibility.

### CROSS REFERENCE TO RELATED APPLICATIONS

This application is a 371 of International Application No. PCT/CN2016/105422 filed Nov. 11, 2016, which claims priority to Chinese Patent Application No. 201510764258.3, filed Nov. 11, 2015, both of which are hereby incorporated by reference in their entirety. Part of the data disclosed in this application was published on Nov. 5, 2016 in Journal of Alloys and Compounds, entitled “Free-standing Au inverse opals for enhanced glucose sensing”.

### FIELD OF THE INVENTION

The invention relates to methods for producing three-dimensional ordered porous microstructures. The methods disclosed herein have an advantage of reducing the processing time, while the three-dimensional ordered porous microstructures produced thereby exhibit excellent integrity and high reproducibility.

### DESCRIPTION OF THE RELATED ART

A highly ordered porous material having a pore size close to the wavelength of light may possess unique and useful optical properties, making it applicable in various technical fields, such as photocatalysis, biological carriers, adsorption, filtration, electrical insulation, semiconductors and micro-detection.

Taking advantage of their unique physical properties, the ordered porous microstructures may change the electromagnetic properties of light waves propagating therein. In such highly ordered porous material, electromagnetic waves will behave like electrons in a crystalline and can be controlled by, for example, changing the geometry, periodicity of pore regularity, structural pattern and dielectric constant of the porous material, without making any modification to the chemical structure of the porous material. As such, porous products with different optical properties may be created by adjusting photonic band-gap and the wavelength property of the porous material. New artificial crystalline material of this type has been called photonic crystal and considered as a class of new generation photoelectric material with high potential in various technical fields.

Ordered porous microstructures are basically made of medium material arranged periodically in one, two or three dimensions. One-dimensional ordered porous microstructures are generally referred to as optical multilayer films, which have commonly served as coatings on optical lenses. The periodic multilayer films exhibit one-dimensional photonic band-gaps in which photons are prohibited from propagating through the films and, as a result, certain wavelengths of light are reflected efficiently. Recently, periodic two- and three-dimensional microstructures have drawn considerable attention.

It is known in the art that a three-dimensional ordered porous microstructure having photonic crystal properties can be produced by self-assembling mono-sized polystyrene, poly(methyl methacrylate) or silicon dioxide nanospheres on a substrate by means of gravity sedimentation, centrifugation or vacuum filtration to create a three-dimensional ordered microstructure on the substrate, followed by using the three-dimensional ordered microstructure as a template in which inorganic siloxane monomers are then applied and subjected to a sol-gel reaction, and finally by removal of the substrate via calcination or extraction. However, the conventional process described above has to take several days to produce the three-dimensional ordered microstructure, making mass production unfavorable. Moreover, the microstructures thus fabricated often have a poor regularity, causing the three-dimensional ordered porous products produced thereby to suffer from the drawbacks of unsatisfied integrity and reproducibility and limited size.

R.O.C. Patent Publication No. 201544638 discloses a method for fabricating a three-dimensional ordered microstructure, which involves application of a shaping electric field to facilitate the self-assembling of particles, thereby forming a hexagonal closest packing of the particles. Compared with the conventional self-assembling processes, the electric field-driven self-assembling step of the method has advantages of time-saving and high productivity.

Nevertheless, there is still a need for technology that can produce three-dimensional ordered microstructures in a time-effective manner and produce large-area three-dimensional ordered porous microstructures with high integrity and reproducibility.

### SUMMARY OF THE INVENTION

The methods for three-dimensional ordered porous microstructure disclosed herein can overcome the drawbacks described above.

In the first aspect provided herein is a method for producing a three-dimensional ordered porous microstructure, comprising the steps of:
a. providing a substrate having a main surface;
b. forming a three-dimensional ordered microstructure of particles on the main surface, so that interstitial voids are formed between the particles and the main surface and among the respective particles;
c. forming a sacrificial layer on the main surface by filling a sacrificial material into the interstitial voids until reaching a first predetermined thickness;
d. filling an inverse opal material into the interstitial voids until reaching a second predetermined thickness on the sacrificial layer; and
e. removing the three-dimensional ordered microstructure to obtain the three-dimensional ordered porous microstructure.

In one preferred embodiment of the method disclosed above, the step of forming the three-dimensional ordered microstructure comprises placing the substrate into a suspension uniformly dispersed with the particles, applying a deposition electric field in a direction substantially perpendicular to the main surface, thereby depositing the particles onto the main surface, removing the substrate deposited with the particles from the suspension, and then applying a shaping electric field towards the substrate from periphery of the substrate, so that the particles deposited on the main surface are driven to self-assemble, thereby forming the three-dimensional ordered microstructure.

In the second aspect provided herein is a method for producing a three-dimensional ordered porous microstructure, comprising the steps of:
a. providing a substrate having a main surface;
b. forming a sacrificial layer in a first predetermined thickness on the main surface;
c. forming a three-dimensional ordered microstructure of particles on the sacrificial layer, so that interstitial voids are formed among the respective particles;
d. filling an inverse opal material into the interstitial voids until reaching a second predetermined thickness on the sacrificial layer; and
e. removing the three-dimensional ordered microstructure to obtain the three-dimensional ordered porous microstructure disposed on the sacrificial layer.

In one preferred embodiment of the method disclosed above, the step of forming the three-dimensional ordered microstructure comprises placing the substrate into a suspension uniformly dispersed with the particles, applying a deposition electric field in a direction substantially perpendicular to the main surface, thereby depositing the particles onto the sacrificial layer, removing the substrate deposited with the particles from the suspension, and then applying a shaping electric field towards the substrate from periphery of the substrate, so that the particles deposited on the main surface are driven to self-assemble, thereby forming the three-dimensional ordered microstructure.

In a preferred embodiment, the step of forming the three-dimensional ordered microstructure further comprises vertically orienting the substrate in the suspension before applying the deposition electric field.

In one preferred embodiment, the step of forming the three-dimensional ordered microstructure further comprises horizontally orienting the substrate before applying the shaping electric field.

In one preferred embodiment, the sacrificial material is selected from the group consisting of oxides, polymers and metals.

In one preferred embodiment, the inverse opal material is selected from the group consisting of metals, metal oxides and polymers.

In one preferred embodiment, the sacrificial material is sufficiently distinct from the inverse opal material in terms of a physical and chemical property.

Preferably, in the step of forming the three-dimensional ordered microstructure, at least some of the particles in the three-dimensional ordered microstructure achieve a close-packing arrangement.

In one preferred embodiment, the methods for producing a three-dimensional ordered porous microstructure further comprise a step of removing the sacrificial layer before or after the removal of the three-dimensional ordered microstructure.

In one preferred embodiment, the methods further comprise a step of patterning either the substrate or the sacrificial layer before the step of forming the three-dimensional ordered microstructure, such that the particles can only be deposited within confined regions on the substrate or the sacrificial layer.

According to a preferred aspect of the method disclosed herein, the three-dimensional ordered microstructure is formed by self-assembling the particles deposited on a substrate into a close-packing arrangement. The three-dimensional ordered microstructure is then used as a template, and a sacrificial layer is further used as a supportive structure, so as to produce a large-area three-dimensional ordered porous microstructure with high integrity and reproducibility.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a flowchart according to the first embodiment of the invention;

FIG. 2 is a schematic diagram showing that particles in the suspension are driven to deposit by applying a deposition electric field according to the first embodiment of the invention;

FIG. 3 is a schematic diagram showing that the particles are driven to undergo self-assembling by applying a shaping electric field according to the first embodiment of the invention;

FIG. 4 is a schematic diagram showing the formation of a sacrificial layer according to the first embodiment of the invention;

FIG. 5 is a schematic diagram showing the filling of the interstitial voids according to the first embodiment of the invention;

FIG. 6 is a schematic diagram showing that the three-dimensional ordered microstructure has been removed according to the first embodiment of the invention;

FIG. 7 is a flowchart according to the second embodiment of the invention;

FIG. 8 is a schematic diagram showing the formation of a sacrificial layer according to the second embodiment of the invention;

FIG. 9 is a schematic diagram showing that particles in the suspension are driven to deposit by applying a deposition electric field according to the second embodiment of the invention;

FIG. 10 is a schematic diagram showing that the particles are driven to undergo self-assembling by applying a shaping electric field according to the second embodiment of the invention;

FIG. 11 is a schematic diagram showing the filling of the interstitial voids according to the second embodiment of the invention;

FIG. 12 is a schematic diagram showing that the three-dimensional ordered microstructure has been removed according to the second embodiment of the invention;

FIG. 13 is an electron microscopic image of a three-dimensional ordered porous microstructure produced according to the first embodiment of the invention; and

FIG. 14 is an electron microscopic image of a three-dimensional ordered porous microstructure produced according to the second embodiment of the invention.

### DETAILED DESCRIPTION OF THE INVENTION

According to the invention, the term “three-dimensional ordered microstructure” may refer to any microstructure formed through a three-dimensional ordered arrangement of constituting particles. The term “ordered” as used herein may refer to the particles being arranged in a regular or periodic manner, preferably being spaced apart from one another in an equal distance. The particles which constitute the microstructure are normally made uniform in particle size, shape, chemical composition, inner texture and surface property, such that the non-covalent interactions among them are facilitated, whereby they spontaneously arrange themselves into a lattice-like regular structure. In a preferred embodiment, the particles are equal spheres having a uniform particle size, more preferably having a uniform particle size ranging from 1 nanometer to 1000 microns, such as from 10 nanometers to 100 microns. Non-limiting examples of the material that may be used to produce the particles include polymeric materials, inorganic materials and metallic materials. Examples of the polymeric materials include but are not limited to polystyrene (PS), poly(methyl methacrylate) (PMMA), polyacrylates, poly(benzyl methacrylate), poly(α-methyl styrene), poly(phenyl methacrylate), poly(biphenyl methacrylate), poly(cyclohexyl methacrylate), acrylonitrile-styrene copolymers and styrene-methyl methacrylate copolymers. Examples of the inorganic materials include but are not limited to titanium oxide, zinc oxide, cerium oxide, tin oxide, thallium oxide, barium oxide, aluminum oxide, yttrium oxide, zirconium oxide, copper oxide, nickel oxide and silicon oxide. Examples of the metallic materials include but are not limited to gold, silver, copper, platinum, aluminum, zinc, cerium, thallium, barium, yttrium, zirconium, tin, titanium, cadmium, iron and the alloys thereof. In a preferred embodiment, the particles used are polystyrene particles or silicon dioxide particles. Processes for manufacturing the micron- or nano-scale particles are known in the art. For instance, in the case where the particles used are made of polystyrene, an emulsifier-free emulsion polymerization process may be employed to synthesize polystyrene spheres having a particle size of hundred nanometers.

In a preferred embodiment, at least some of the particles in the three-dimensional ordered microstructure are in a close-packing arrangement, i.e., adjacent particles being tangent to one another and the centers of any three mutually tangent particles forming an equilateral triangle, while each particle has a coordination number of 12 and there leaves triangular voids among the particles. More preferably, at least some of the particles in the three-dimensional ordered microstructure are in a hexagonal closest packing (hcp) arrangement, a face centered cubic packing (fcc) arrangement, or a combined arrangement thereof. The inverse structure produced by using the three-dimensional ordered microstructure stated above as a template may be referred to herein as a three-dimensional ordered porous microstructure.

The three-dimensional ordered microstructure stated above can be formed by self-assembling of the particles. The term “self-assembling” or “self-assemble” as used herein may refer to a process of micron- or nano-scale particles aggregating into the three-dimensional ordered microstructure in response to the conditions present in the environment. In particular, self-assembling refers to a process in which the particles interact non-covalently with one another to spontaneously form three-dimensional ordered microstructure under near thermodynamic equilibrium conditions. The inventive methods may enhance the deposition of the particles by applying a deposition electric field and further facilitate the self-assembling of the particles by applying a shaping electric field.

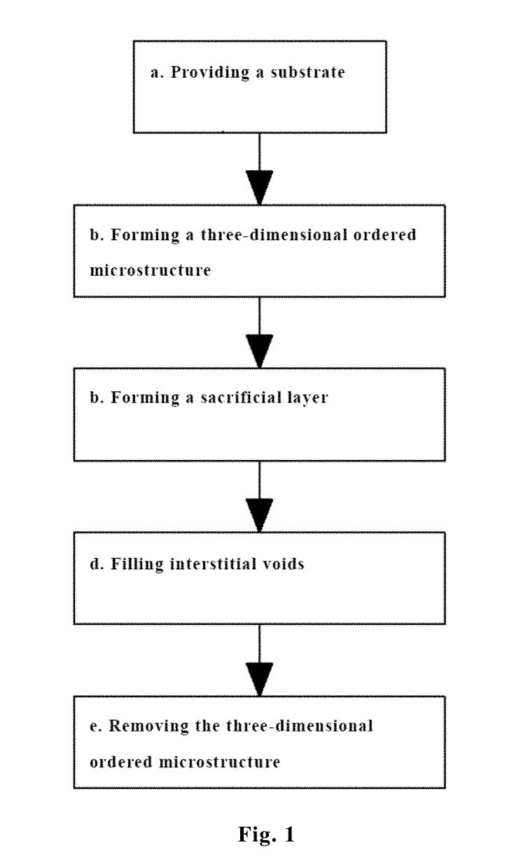

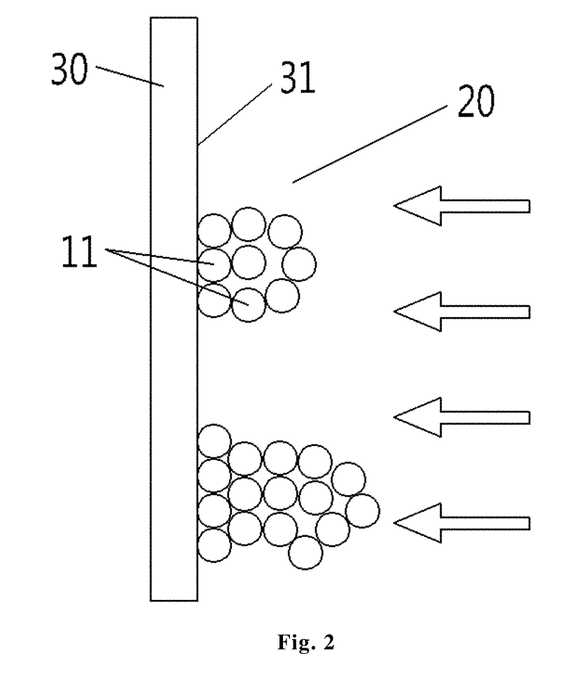

According to the invention, the methods disclosed herein have an advantage of reducing the processing time, while the three-dimensional ordered porous microstructures produced thereby exhibit excellent integrity and high reproducibility. FIG. 1 is a flowchart showing the method according to the first embodiment of the invention. The method comprises the following steps: a. providing a substrate; b. forming a three-dimensional ordered microstructure; c. forming a sacrificial layer; d. filling interstitial voids; and e. removing the three-dimensional ordered microstructure, as illustrated in FIGS. 2-6.

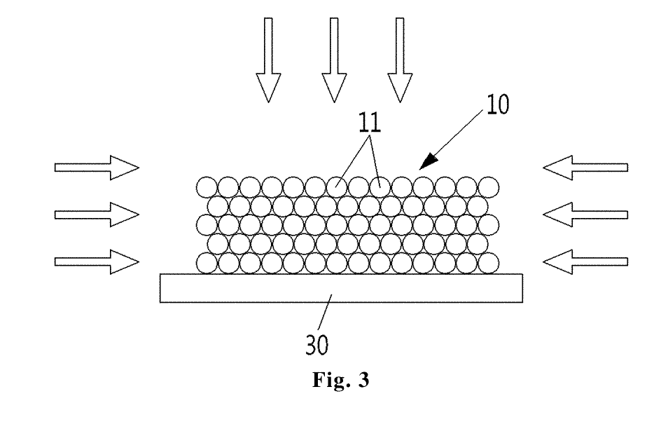

The step of forming the three-dimensional ordered microstructure may be referred from the disclosure provided in R.O.C. Patent Publication No. 201544638, which is hereby incorporated by reference in its entirety. First, a suspension 20 is prepared, in which a plurality of colloid spherical particles 11 are uniformly dispersed. For example, in the case where the colloid spherical particles used are made of polystyrene or silicon dioxide, the suspension 20 may be prepared by uniformly dispersing the particles in a solvent. Suitable solvents include any known solvents which can achieve the purpose of uniformly dispersing the particles without chemically reacting with the particles and the other participants existing in the method. The solvent may be either an organic solvent or an aqueous solvent, including but not limited to water and C₁₋₆ alkanols, preferably anhydrous ethanol. Since the colloid spherical particles 11 dispersed in the solvent are imparted with surface charges by applying an external electric field of appropriate strength, they are driven by the electric field to move towards the electrode of opposite charge. A substrate 30 is placed into the suspension 20, and a deposition electric field is applied in a direction substantially perpendicular to the substrate 30 (as shown in FIG. 2), thereby depositing the particles 11 in the suspension 20 onto the main surface 31 of the substrate 30 at a rapid rate. The substrate 30 provides physical support to and maintains the integrity of the entire structure during the fabrication. Therefore, the material and thickness of the substrate 30 may vary, so long as the substrate 30 is adapted to achieve the purposes stated above and substantially chemically inert to the other participants in the method. The application of the deposition electric field is allowed to last for a predetermined period of time. The substrate 30 on which the particles 11 are deposited with a predetermined thickness is then removed from the suspension 20, and the particles 11 are kept to have suitable moisture contents such that their mobility can be maintained. The predetermined thickness of the particles 11 may vary, normally within a range of 1-100,000 microns, depending on the desired thickness of the three-dimensional ordered microstructure to be produced. Afterwards, a shaping electric field is applied towards the substrate 30 from periphery of the substrate 30 (as shown in FIG. 3), so that the particles 11 irregularly deposited on the main surface 31 of the substrate 30 are driven to sway slightly. As a result, the particles 11 are facilitated to self-assemble into a three-dimensional ordered microstructure 10 on the main surface 31, where at least part of the particles 11 are in a close-packing arrangement. In the three-dimensional ordered microstructure 10, interstitial voids 12 are formed between and defined by the particles 11 and the main surface 31 as well as among the respective particles 11. The strengths of the electric fields applied may vary, so long as the electric field can achieve the purposes of deposition and self-assembly of the particles 11 as described above. In one preferred embodiment, the strength of the deposition electric field is set within a range of 0-100 Volts/cm, such as 5-50 Volts/cm. In one preferred embodiment, the strength of the shaping electric field is set within a range of 0-3000 Volts/cm, such as 200-1000 Volts/cm. Desirably, the electric fields are independently a pulsed electric field and, more preferably, the shaping electric field is a pulsed electric field whose polarity is reversed periodically to generate an effect similar to that achieved by tapping a vessel containing marbles, thereby enhancing the self-assembling of the particles 11 into a close-packing arrangement. It is important to note that the application of the deposition electric field and the shaping electric field according to the invention is intended to facilitate and therefore speed up the packing and arrangement of the particles 11, rather than to affect the final configuration of the three-dimensional ordered microstructure produced. In addition, the substrate 30 and the main surface 31 thereof may be fabricated either in the form of a plate as shown in the drawings or in any other geometrical configuration, such as in a cylindrical or corrugated configuration having a curved main surface.

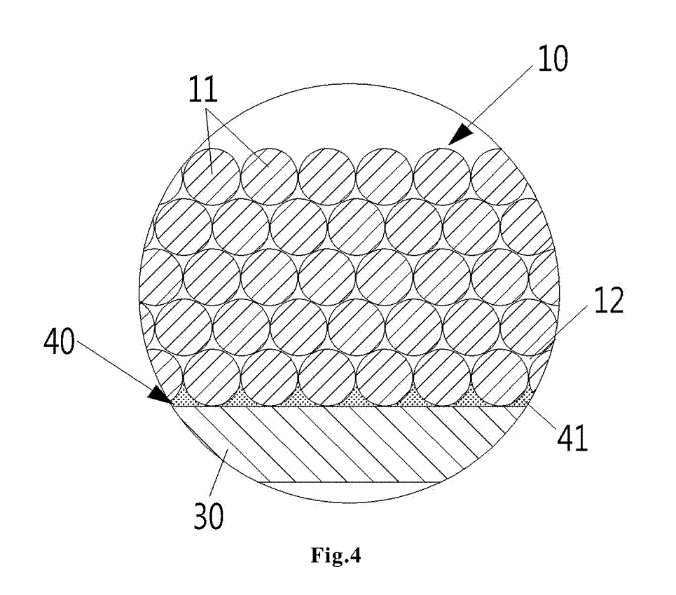

In the step of forming a sacrificial layer 40, a sacrificial material 41 is filled into the interstitial voids 12 until it reaches a first predetermined thickness (as shown in FIG. 4), thereby forming the sacrificial layer 40 on the main surface 31. According to the invention, the term “sacrificial layer” as used herein may refer to a thin layer, which is useful in providing support to one or more constituting members and will be effectively removed subsequently without damaging or interfering with the one or more constituting members. During the fabrication of the three-dimensional ordered porous microstructure, the sacrificial layer 40 provides physical support to and maintains the integrity of the entire structure. The sacrificial material 41 is sufficiently distinct from the inverse opal material 51 used subsequently in terms of a physical and chemical property, such as melting point, solubility in acidic or alkaline solvents and lattice constant. Preferably, the sacrificial material 41 and the inverse opal material 51 belong to different chemical species. The sacrificial layer 40 can be removed from the inverse opal material 51 by virtue of the difference between them. As such, the type of the sacrificial material 41 and the thickness of the sacrificial layer 40 may vary, so long as the purposes described above can be achieved. The first predetermined thickness is normally within a range from about 1 nanometer to about 1 micron, preferably from about 1 nanometer to about 100 microns. The sacrificial material 41 is preferably selected from the group consisting of oxides, polymers and metals. Examples of the oxides include but are not limited to indium tin oxide (ITO). Examples of the polymers include but are not limited to polypyrrole. Examples of the metals include but are not limited to gold, titanium, platinum, nickel, copper, silver, stainless steel and graphite. The sacrificial material 41 may be built up by, for example, sputtering, electroplating, chemical vapor deposition and atomic layer deposition. The sacrificial layer 40 may be removed by any process known in the technical field of micromachining, including but not limited to chemical etching, plasma etching, solubilizing with a solvent, photolithography and mechanical stripping. It is important to note that in the case where the sacrificial layer 40 is to be removed by mechanical stripping, the sacrificial material 41 is sufficiently distinct from the inverse opal material 51 in terms of lattice constant, as a means to facilitate the removal of the sacrificial layer 40. According to the invention, the presence of the sacrificial layer may help maintaining the structural integrity of the three-dimensional ordered porous microstructure when the microstructure is being removed from the substrate.

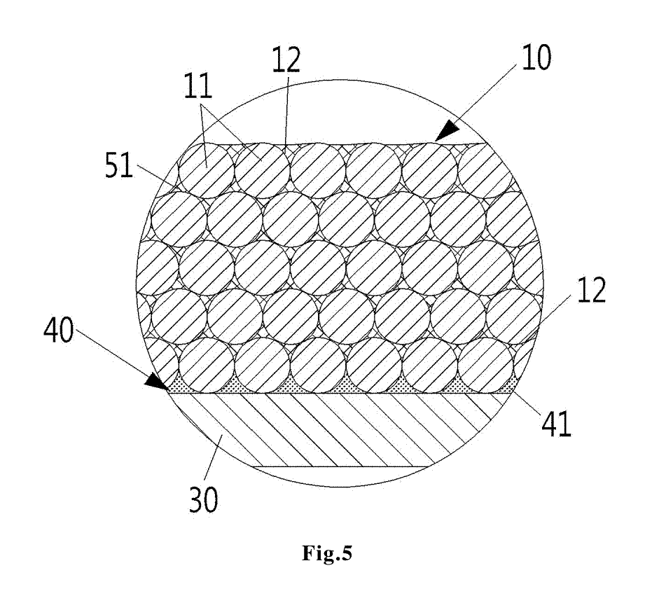

In the step of filling interstitial voids, an inverse opal material 51 is filled into the interstitial voids 12 of the three-dimensional ordered microstructure 10 until it reaches a second predetermined thickness on the sacrificial layer 40 (as shown in FIG. 5). The second predetermined thickness may vary and is normally set such that all of the interstitial voids 12 among the particles 11 are filled up and that the inverse opal material 51 can be even applied until reaching a level higher than the interstitial voids 12. The inverse opal material 51 includes but is not limited to: metals, such as gold, silver, copper, nickel, platinum and nickel-tungsten alloys; oxides, such as zinc oxide, silicon dioxide and cuprous oxide; and polymers, such as polystyrene (PS), poly(methyl methacrylate) (PMMA), polypyrrole, polyethylene, polyvinyl chloride and polysiloxanes. The filling of the inverse opal material 51 may be performed by, for example, sputtering, electroplating, chemical vapor deposition and atomic layer deposition.

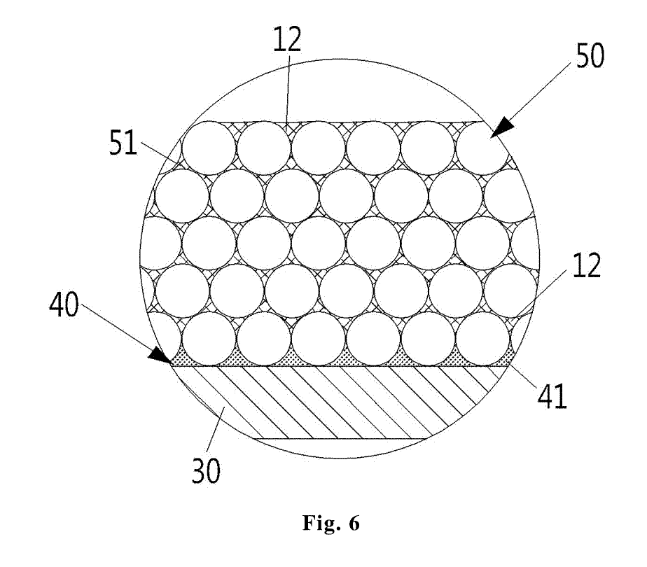

In the step of removing the three-dimensional ordered microstructure, the particles 11 existing in the three-dimensional ordered microstructure 10 are removed after the inverse opal material 51 is cured (as shown in FIG. 6). Techniques for removal of the microstructure are known in the art, which include but are not limited to chemical removal processes and thermal removal processes. For example, in the embodiment where a chemical removal process is used, the three-dimensional ordered microstructure 10 may be treated with an organic solvent capable of dissolving the particles 11, such as toluene, so as to separate the particles 11 from the cured inverse opal material 51. By virtue of performing the steps a-e above, a three-dimensional ordered porous microstructure 50 is produced with excellent integrity and high reproducibility.

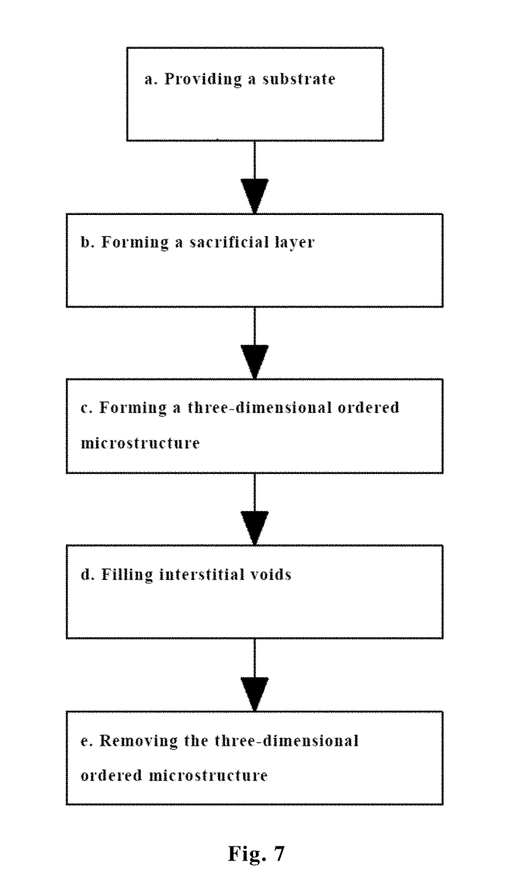

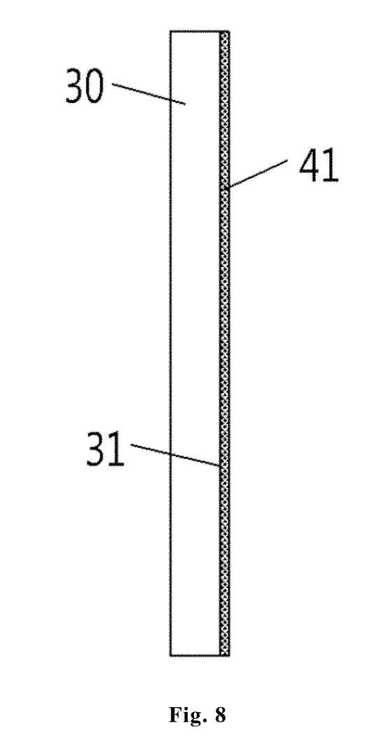

FIG. 7 is a flowchart showing the method for producing a three-dimensional ordered porous microstructure according to the second embodiment of the invention. The method comprises the following steps: a. providing a substrate; b. forming a sacrificial layer; c. forming a three-dimensional ordered microstructure; d. filling interstitial voids; and e. removing the three-dimensional ordered microstructure, as illustrated in FIGS. 8-12.

As shown in FIG. 8, the step of forming a sacrificial layer 40 is performed before the step of forming a three-dimensional ordered microstructure 10. The process and material for forming the sacrificial layer 40 are substantially the same as those stated in the first embodiment of the invention.

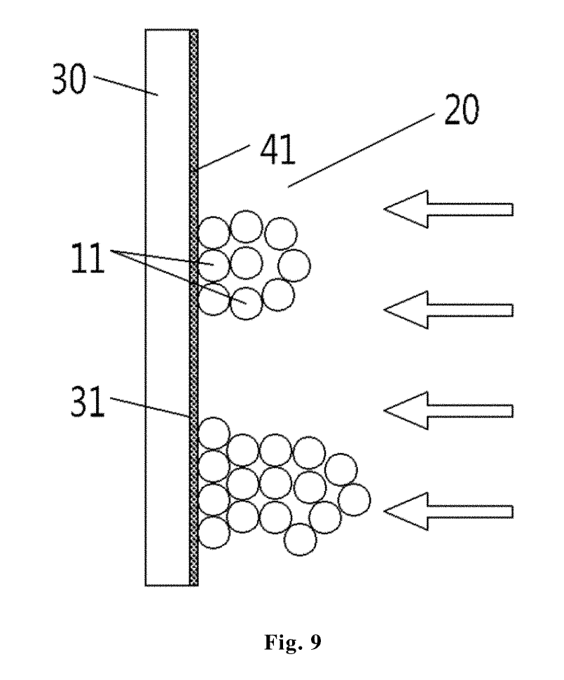

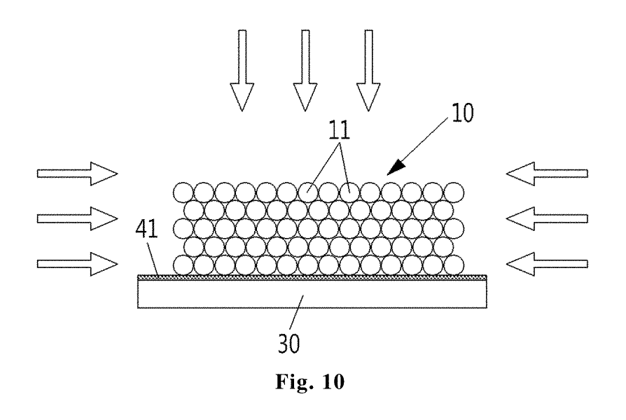

As shown in FIGS. 9 and 10, the process and material for forming the three-dimensional ordered microstructure 10 are substantially the same as those stated in the first embodiment of the invention, with a major difference in that the three-dimensional ordered microstructure 10 is constructed on the sacrificial layer 40.

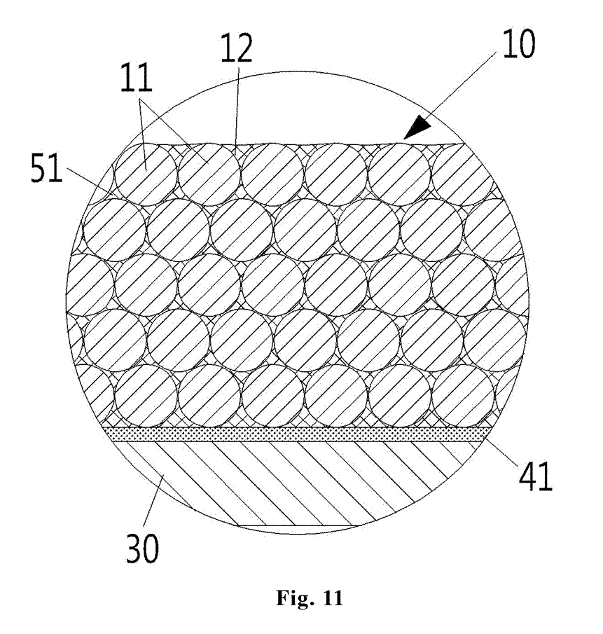

As shown in FIG. 11, the process and material used in the step of filling the interstitial voids 12 are substantially the same as those stated in the first embodiment of the invention.

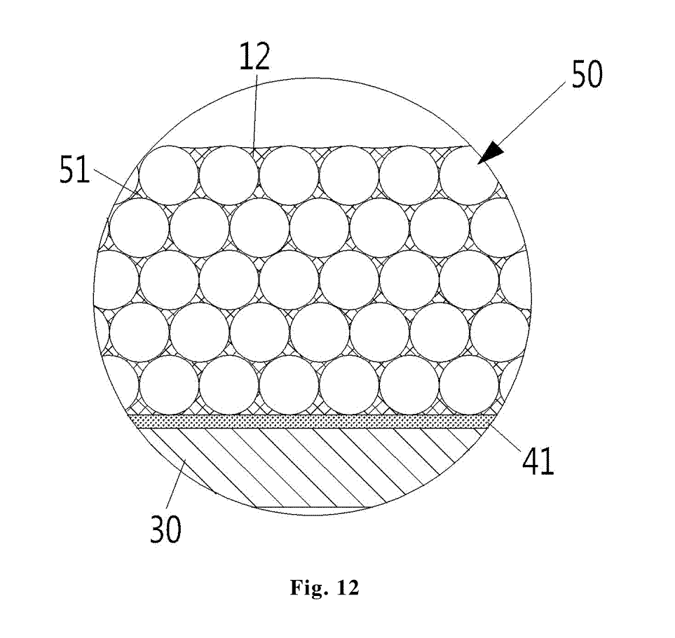

As shown in FIG. 12, the process and material used in the step of removing the three-dimensional ordered microstructure 10 are substantially the same as those stated in the first embodiment of the invention. By virtue of performing the steps a-e above, a three-dimensional ordered porous microstructure 50 is produced with excellent integrity and high reproducibility.

Before utilizing the three-dimensional ordered porous microstructure 50 disclosed herein in a desired application, it can be easily separated from the substrate 30 by removing the sacrificial layer 40. In one preferred embodiment, the free-standing three-dimensional ordered porous microstructure 50 may serve as a three-dimensional porous scaffold. The step of removing the sacrificial layer 40 may be carried out either before or after the removal of the three-dimensional ordered microstructure 10. In other preferred embodiment, the free-standing three-dimensional ordered porous microstructure 50 may function as a porous template, into which other crystalline material may be filled. After the crystalline material is cured, the three-dimensional ordered porous microstructure 50 may be removed to obtain a three-dimensional ordered microstructure having a predetermined function.

According to one preferred embodiment of the invention, in the step of forming the three-dimensional ordered microstructure, the deposition electric field is applied to act on the particles such that the particles are deposited onto the substrate rapidly, and the shaping electric field is applied subsequently such that the particles deposited on the substrate surface are urged to jostle one another and self-assemble into a three-dimensional ordered microstructure composed of a close-packing of the particles. The methods disclosed herein have an advantage of reducing the processing time for producing three-dimensional ordered porous microstructures, while the three-dimensional ordered porous microstructures produced thereby exhibit excellent integrity and high reproducibility. As such, the inventive methods are beneficial for production of large-area three-dimensional ordered porous microstructures.

In addition, according to the methods for producing a three-dimensional ordered porous microstructure disclosed herein, either the main surface 31 of the substrate 30 or the sacrificial layer 40 may be patterned before the formation of the three-dimensional ordered microstructure thereon, such that the particles can only be deposited within confined regions on the substrate or the sacrificial layer. According to one preferred embodiment of the invention, the step of forming the three-dimensional ordered microstructure further comprises vertically orienting the substrate 30 in the suspension before applying the deposition electric field and/or horizontally orienting the substrate 30 before applying the shaping electric field.

Moreover, the step of forming the three-dimensional ordered microstructure may involve formation of the three-dimensional ordered microstructure composed of a close-packing of the particles on the main surface of the substrate by means of gravity sedimentation, centrifugation, vacuum filtration or electrophoresis.

The following examples are given for the purpose of illustration only and are not intended to limit the scope of the invention.

### Example 1: Preparation of Polystyrene Particles

A 40 mL styrene monomer solution (99.6 wt %) was added into a 300 mL sodium bicarbonate (12 mM) and sodium styrene sulfonic acid solution. The mixture was stirred at 350 rpm for 1 hour, while its temperature was kept at 65° C. Then, potassium sulfate (0.25 g) was added into the mixture to initiate the polymerization reaction. After 16 hours, all the styrene monomers were completely consumed. In this example, polystyrene particles with diameters of 300, 405 and 600 nm were prepared by controlling the concentration of sodium styrene sulfonic acid solution at 0.8, 0.48, and 0.13 mM, respectively.

### Example 2: Fabrication of Three-Dimensionally Ordered Microstructures

Suspensions of polystyrene particles at a concentration of 0.01 g/ml were prepared by dispersing the polystyrene particles of Example 1 in anhydrous ethanol, and the pH was adjusted to 9 using NH₄OH. 2.5×2.5 cm² indium tin oxide (ITO)-coated glass substrates were purchased from UNI-Ward Corporation, Taiwan (under a catalog No. UR-ITO007-0.7; each having a sheet resistance of 7Ω/□ and a thickness of 0.7 mm). A deposition electric field was applied at 10 Volts/cm in a direction generally perpendicular to an ITO-coated substrate described above for 10-15 minutes, thereby depositing the polystyrene particles on the ITO-coated substrate. Three-dimensionally ordered microstructures with a thickness of more than 12 μm were formed by using polystyrene particles having diameters of 300, 405 and 600 nm, respectively.

### Example 3: Fabrication of Three-Dimensional Ordered Porous Microstructures

At the bottom side of each of the three-dimensionally ordered microstructures prepared in Example 2, a thin nickel layer was plated as a sacrificial layer. The Ni plating entailed a galvanostatic current of 2.5 mA/cm² for 5-10 minutes, with the three-dimensionally ordered microstructures used as a working electrode and a 4×4 cm² Ni foil employed as a counter electrode in a Watt's bath electrolyte. Next, a gold aqueous electroplating solution containing 0.05M HAuCl₄, 0.42M Na2SO₃, 0.42M Na₂S₂O₃, and 0.3M Na₂HPO₄ was prepared. An Au layer was then deposited on top of the sacrificial Ni layer by applying a fixed voltage at 0.8V for 90 minutes, with a platinum foil (4×4 cm²) used as a counter electrode. Subsequently, the sample was immersed in ethyl acetate for 24 hours at 25° C. to dissolve away the polystyrene particles, so that a Ni—Au inverse opal film was formed. Finally, the Ni—Au inverse opal film was immersed in a 0.1M HNO₃ solution at 25° C. to dissolve Ni, thereby forming a three-dimensional ordered porous microstructure made of gold. In this example, three-dimensional ordered porous microstructures were prepared using the three-dimensional ordered microstructures having particle diameters of 300, 405, and 600 nm as templates.

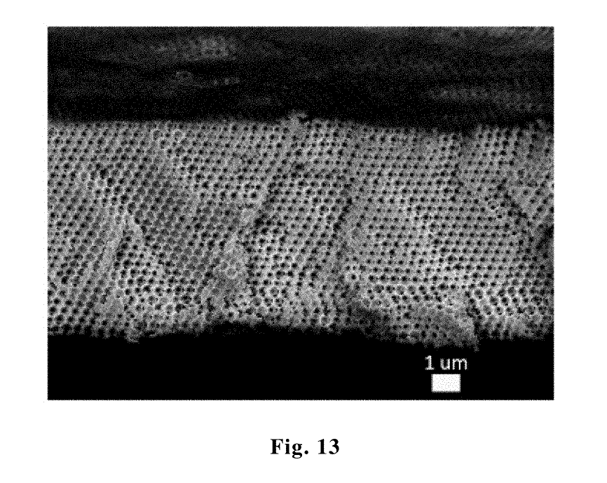

FIG. 13 shows a three-dimensional ordered porous microstructure produced according to the first embodiment of the invention, from which the sacrificial layer has been removed.

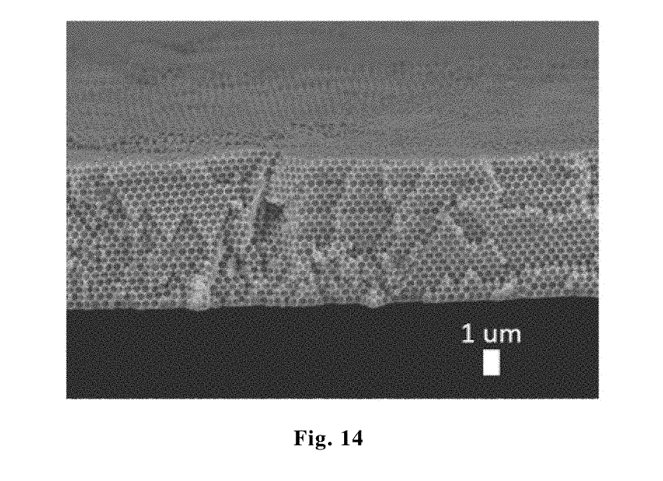

FIG. 14 shows a three-dimensional ordered porous microstructure produced according to the second embodiment of the invention, from which the sacrificial layer has been removed. In this embodiment, as the sacrificial layer is constructed prior to the formation of the three-dimensional ordered microstructure, the sacrificial layer does not interlace with the three-dimensional ordered microstructure. As a result, the constructed level of the inverse opal material (i.e., the second predetermined thickness) and the thickness of the three-dimensional ordered porous microstructure can be effectively controlled, such that three-dimensional ordered porous microstructure thus produced has a smooth contour, and that the openings of the pores formed on the three-dimensional ordered porous microstructure are in substantially the same size.

Compared with the conventional methods, the methods disclosed herein are characterized in that during the formation of the three-dimensional ordered microstructure, the deposition electric field is applied to act on the particles such that the particles are deposited onto the substrate rapidly, and the shaping electric field is applied subsequently such that the particles deposited on the substrate surface are urged to jostle one another and self-assemble into a three-dimensional ordered microstructure composed of a close-packing of the particles. As such, the methods disclosed herein have an advantage of reducing the processing time for producing three-dimensional ordered porous microstructures. The presence of the sacrificial layer in the invention may further help maintaining the structural integrity of the three-dimensional ordered porous microstructure when the microstructure is being separated from the substrate, thereby obtaining a large-area three-dimensional ordered porous microstructure with high integrity and reproducibility. Moreover, the three-dimensional ordered porous microstructure produced thereby may be employed as a template for fabrication of a highly ordered packed three-dimensional microstructure.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

1. A method for producing a three-dimensional ordered porous microstructure, comprising the steps of:
a. providing a substrate having a main surface;
b. forming a three-dimensional ordered microstructure of particles on the main surface, so that interstitial voids are formed between the particles and the main surface and among the respective particles;
c. forming a sacrificial layer on the main surface by filling a sacrificial material into the interstitial voids until reaching a first predetermined thickness;
d. filling an inverse opal material into the interstitial voids until reaching a second predetermined thickness on the sacrificial layer; and
e. removing the three-dimensional ordered microstructure to obtain the three-dimensional ordered porous microstructure.

2. The method for producing a three-dimensional ordered porous microstructure according to claim 1, wherein the step b of forming the three-dimensional ordered microstructure comprises placing the substrate into a suspension uniformly dispersed with the particles, applying a deposition electric field in a direction substantially perpendicular to the main surface, thereby depositing the particles onto the main surface, removing the substrate deposited with the particles from the suspension, and then applying a shaping electric field towards the substrate from periphery of the substrate, so that the particles deposited on the main surface are driven to self-assemble, thereby forming the three-dimensional ordered microstructure.

3. A method for producing a three-dimensional ordered porous microstructure, comprising the steps of:
a. providing a substrate having a main surface;
b. forming a sacrificial layer in a first predetermined thickness on the main surface;
c. forming a three-dimensional ordered microstructure of particles on the sacrificial layer, so that interstitial voids are formed among the respective particles;
d. filling an inverse opal material into the interstitial voids until reaching a second predetermined thickness on the sacrificial layer; and
e. removing the three-dimensional ordered microstructure to obtain the three-dimensional ordered porous microstructure disposed on the sacrificial layer.

4. The method for producing a three-dimensional ordered porous microstructure according to claim 3, wherein the step c of forming the three-dimensional ordered microstructure comprises placing the substrate into a suspension uniformly dispersed with the particles, applying a deposition electric field in a direction substantially perpendicular to the main surface, thereby depositing the particles onto the sacrificial layer, removing the substrate deposited with the particles from the suspension, and then applying a shaping electric field towards the substrate from periphery of the substrate, so that the particles deposited on the main surface are driven to self-assemble, thereby forming the three-dimensional ordered microstructure.

5. The method for producing a three-dimensional ordered porous microstructure according to claim 2, wherein the step b further comprises vertically orienting the substrate in the suspension before applying the deposition electric field.

6. The method for producing a three-dimensional ordered porous microstructure according to claim 5, wherein the step b further comprises horizontally orienting the substrate in the suspension before applying the shaping electric field.

7. The method for producing a three-dimensional ordered porous microstructure according to claim 1, wherein the sacrificial material is selected from the group consisting of oxides, polymers and metals.

8. The method for producing a three-dimensional ordered porous microstructure according to claim 7, wherein the inverse opal material is selected from the group consisting of metals, metal oxides and polymers.

9. The method for producing a three-dimensional ordered porous microstructure according to claim 8, wherein the sacrificial material is sufficiently distinct from the inverse opal material in terms of a property selected from the group consisting of physical and chemical properties to facilitate removal of the sacrificial material from the inverse opal material.

10. The method for producing a three-dimensional ordered porous microstructure according to claim 9, further comprising a step of removing the sacrificial layer before the step e.

11. The method for producing a three-dimensional ordered porous microstructure according to claim 9, further comprising a step of removing the sacrificial layer after the step e.

12. The method for producing a three-dimensional ordered porous microstructure according to claim 6, wherein at least some of the particles in the three-dimensional ordered microstructure achieve a close-packing arrangement after self-assembling.

13. The method for producing a three-dimensional ordered porous microstructure according to claim 4, wherein the step c further comprises vertically orienting the substrate in the suspension before applying the deposition electric field.

14. The method for producing a three-dimensional ordered porous microstructure according to claim 13, wherein the step c further comprises horizontally orienting the substrate in the suspension before applying the shaping electric field.

15. The method for producing a three-dimensional ordered porous microstructure according to claim 14, wherein at least some of the particles in the three-dimensional ordered microstructure achieve a close-packing arrangement after self-assembling.

16. The method for producing a three-dimensional ordered porous microstructure according to claim 3, wherein the sacrificial material is selected from the group consisting of oxides, polymers and metals.

17. The method for producing a three-dimensional ordered porous microstructure according to claim 16, wherein the inverse opal material is selected from the group consisting of metals, metal oxides and polymers.

18. The method for producing a three-dimensional ordered porous microstructure according to claim 17, wherein the sacrificial material is sufficiently distinct from the inverse opal material in terms of a property selected from the group consisting of physical and chemical properties to facilitate removal of the sacrificial material from the inverse opal material.

19. The method for producing a three-dimensional ordered porous microstructure according to claim 18, further comprising a step of removing the sacrificial layer before the step e.

20. The method for producing a three-dimensional ordered porous microstructure according to claim 18, further comprising a step of removing the sacrificial layer after the step e.
